(19) United States
(12) Patent Application Publication
(10) Pub. No.: US 2013/0271854 A1
(43) Pub. Date: Oct. 17, 2013

(54) COMBINATION LENS

(71) Applicants: Ching-Shan Yang, Tainan (TW); Wu-Li Wang, Tainan (TW)

(72) Inventors: Ching-Shan Yang, Tainan (TW); Wu-Li Wang, Tainan (TW)

(73) Assignee: GLOBAL MICROPTICS COMPANY, Tainan (TW)

(21) Appl. No.: 13/446,889

(22) Filed: Apr. 13, 2012

(51) Int. Cl. G02B 3/00

(52) U.S. Cl. 359/796

(57) ABSTRACT

A combination lens includes a first lens having a first lens portion on a side thereof and at least a protrusion around the first lens portion, and a second lens having a second lens portion on a side thereof and at least a recess around the second lens portion. The first lens is bonded to the second lens by engaging the protrusion with the recess. Therefore, the engagement of the protrusion and the recess may fix the first and the second lenses in a right position before the glue solidified.

### BACKGROUND OF THE INVENTION

1. Field of the Invention

The present invention relates generally to an optical device, and more particularly to a combination lens.

2. Description of the Related Art

In recent days, more and more image pick-up apparatus, such as digital camera and cell phone, are equipped with an image capture device, such as charge coupled device (CCD) or complementary metal oxide semiconductor (CMOS), and theses image pick-up apparatus are made as smaller as possible so that the image capture devices are asked as smaller as possible as well.

In order to reduce the size, more and more image capture devices are made without a housing by stacking and bonding the lenses. FIG. 1 shows a conventional combination lens 2, including a first lens 30 and a second lens 40 stacked on and attached to the first lens 30. The first lens 30 has a first lens portion 31 on a side thereof and a flat portion 32 around the first lens portion 31. The second lens 40 has a second lens portion 41 on a side thereof and a flat portion 42 around the second lens portion 41. Glue S2 is added between the flat portions 32, 42 of the first and the second lenses 30, 40 to bond the first and the second lenses 30, 40 together. The first lens portion 31 of the first lens 30 faces the second lens portion 41 of the second lens 40.

However, the light axes of the first and the second lenses 30, 40 must be aligned so that it is a big problem to fix and align the first and the second lenses 30, 40 before the glue S2 solidified because of the flat portions 32, 42. The conventional combination lens 2 will have a poor optical performance when the first and the second lenses 30, 40 are not aligned, and that will waste a lot of efforts in checking the alignment of the lenses. Therefore, the conventional combination lens 2 still has some places to be improved.

### SUMMARY OF THE INVENTION

The primary objective of the present invention is to provide a combination lens, which has an easy and accurate way to align the lenses.

According to the objective of the present invention, a combination lens includes a first lens having a first lens portion on a side thereof and at least a protrusion around the first lens portion, and a second lens having a second lens portion on a side thereof and at least a recess around the second lens portion. The first lens is bonded to the second lens by engaging the protrusion with the recess.

In an embodiment, a height of the protrusion is greater than a depth of the recess.

In an embodiment, a depth of the recess is greater than a height of the protrusion.

In an embodiment, an angle between a sidewall of the protrusion of the first lens and a horizontal plane is in a range between 60 degrees and 90 degrees.

In an embodiment, an angle between a sidewall of the protrusion of the first lens and a horizontal plane is in a range between 75 degrees and 85 degrees.

In an embodiment, an angle between a sidewall of the recess of the second lens and a horizontal plane is in a range between 90 degrees and 120 degrees.

In an embodiment, an angle between a sidewall of the recess of the second lens and a horizontal plane is in a range between 95 degrees and 105 degrees.

In an embodiment, the first lens portion of the first lens is concave, and the second lens portion of the second lens is concave.

In an embodiment, the first lens portion of the first lens is convex, and the second lens portion of the second lens is concave.

In an embodiment, the first lens portion of the first lens is concave, and the second lens portion of the second lens is convex.

Therefore, the engagement of the protrusion and the recess may fix the first and the second lenses before the glue solidified in an easy and accurate way.

### BRIEF DESCRIPTION OF THE DRAWINGS

FIG. 1 is a sketch diagram of the conventional combination lens;

FIG. 2 is a sketch diagram of a preferred embodiment of the present invention;

FIG. 3 is a sketch diagram of the preferred embodiment of the present invention, showing the engagement of the protrusion and the recess; and

FIG. 4 is a sketch diagram of the preferred embodiment of the present invention, showing the protrusion longer than the recess.

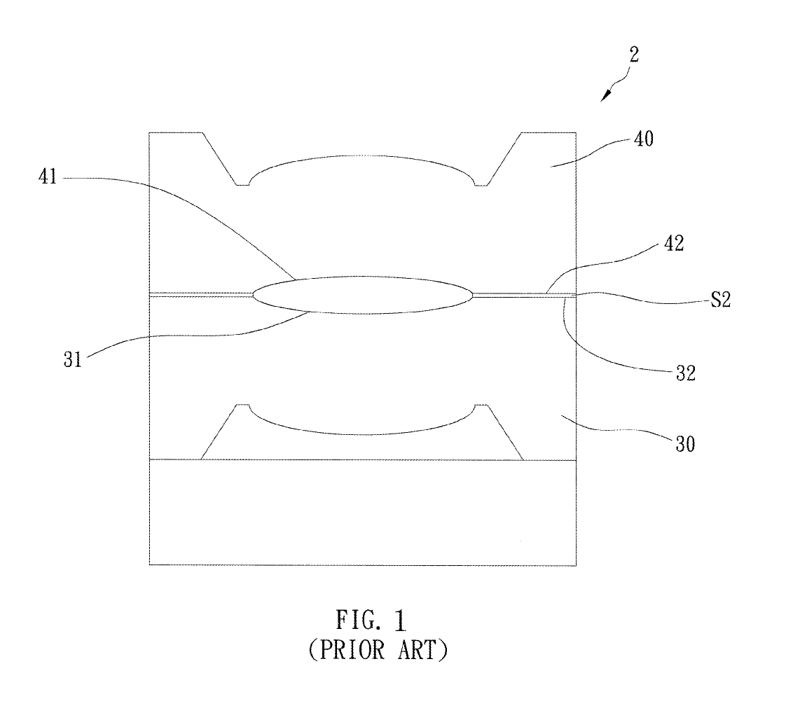

### DETAILED DESCRIPTION OF THE INVENTION

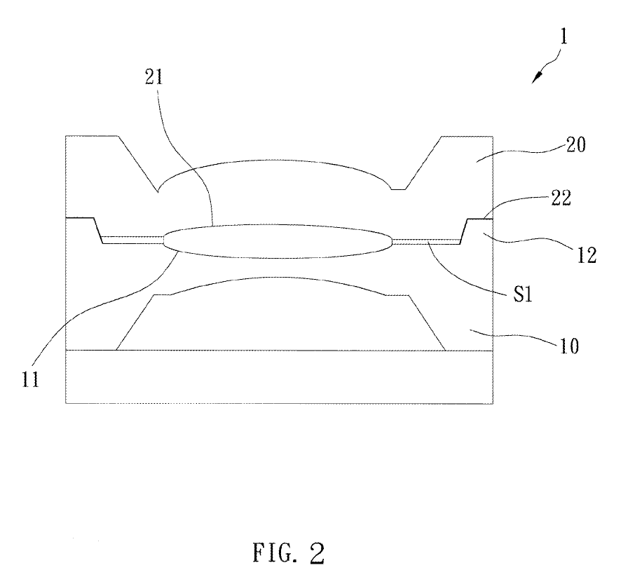

As shown in FIG. 2, a combination lens 1 of the preferred embodiment of the present invention includes a first lens 10 and a second lens 20.

The first lens 10 has a concave first lens portion 11 on a side thereof and an annular protrusion 12 around the first lens portion 11.

The second lens 20 has a concave second lens portion 21 on a side thereof and an annular recess 22 around the second lens portion 21.

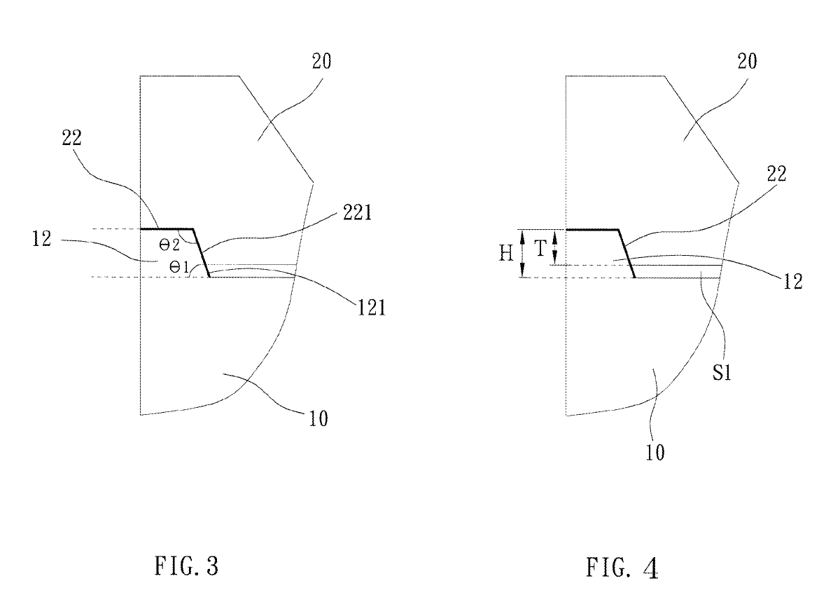

The second lens 20 is connected to the first lens 10 by engaging the protrusion 12 with the recess 22, and therefore, the first lens portion 11 faces the second lens portion 21. As shown in FIG. 3, an angle θ1 between a sidewall 121 of the protrusion 12 of the first lens 10 and a horizontal plane is in a range between 60 degrees and 90 degrees, and is more preferable in a range between 75 degrees and 85 degrees. An angle θ2 between a sidewall 221 of the recess 22 of the second lens 20 and a horizontal plane is in a range between 90 degrees and 120 degrees, and is more preferable in a range between 95 degrees and 105 degrees. Therefore, a sum of θ1 and θ2 equals or approaches 180 degrees. The designation of the angles of the sidewalls 121, 221 of the protrusion 12 and the recess 22 may increase the speed and accuracy of the engagement of the protrusion 12 and the recess 22, and no slid or shift between the first and the second lenses 10, 20 when the protrusion 12 and the recess 22 are engaged.

As shown in FIG. 4, a height H of the protrusion 12 is greater than a depth T of the recess 22 so that a gap will be formed between the first and the second lenses 10, 20 for glue S1 to bond the first and the second lenses 10, 20 together. It is easy to understand that the gap will be formed as well while the depth T of the recess 22 is greater than the height H of the protrusion 12 (not shown).

In practice, it may provide sensors (not shown) surround the lenses to check the alignment of the first and the second lenses 10, 20. If the sensors detect an inclination of the second lens 20 which means the protrusion 12 does not fully engage the recess 22 and the second lens 20 is not on the right position. The operator may fix this problem easily by moving the second lens 20 to let the protrusion 12 drop into the recess 22.

The embodiment teaches both the lens portions 11, 12 of the first and second lenses 10, 20 are concave. In practice, it may be a concave first lens portion and a convex second lens portion, or a convex first lens portion and a concave second lens portion.

Besides, it may provide two or more concentric protrusions on the first lens and recesses on the second lens to fit the protrusions, and the shape and size of the protrusion and the recess may be changed, of course.

The description above is a few preferred embodiments of the present invention and the equivalence of the present invention is still in the scope of claim construction of the present invention.

What is claimed is:

1. A combination lens, comprising:
a first lens having a first lens portion on a side thereof and at least a protrusion around the first lens portion; and
a second lens having a second lens portion on a side thereof and at least a recess around the second lens portion;
wherein the first lens is bonded to the second lens by engaging the protrusion with the recess.

2. The combination lens as defined in claim 1, wherein a height of the protrusion is greater than a depth of the recess.

3. The combination lens as defined in claim 1, wherein a depth of the recess is greater than a height of the protrusion.

4. The combination lens as defined in claim 1, wherein an angle between a sidewall of the protrusion of the first lens and a horizontal plane is in a range between 60 degrees and 90 degrees.

5. The combination lens as defined in claim 1, wherein an angle between a sidewall of the protrusion of the first lens and a horizontal plane is in a range between 75 degrees and 85 degrees.

6. The combination lens as defined in claim 1, wherein an angle between a sidewall of the recess of the second lens and a horizontal plane is in a range between 90 degrees and 120 degrees.

7. The combination lens as defined in claim 1, wherein an angle between a sidewall of the recess of the second lens and a horizontal plane is in a range between 95 degrees and 105 degrees.

8. The combination lens as defined in claim 1, wherein both the first lens portion of the first lens and the second lens portion of the second lens are concave.

9. The combination lens as defined in claim 1, wherein the first lens portion of the first lens is convex, and the second lens portion of the second lens is concave.

10. The combination lens as defined in claim 1, wherein the first lens portion of the first lens is concave, and the second lens portion of the second lens is convex.
